(19) United States
(12) Patent Application Publication
(10) Pub. No.: US 2018/0269581 A1
(43) Pub. Date: Sep. 20, 2018

(54) ANTENNA DEVICE

(71) Applicant: DENSO WAVE INCORPORATED, Chita-gun (JP)

(72) Inventor: Yosuke HIRAIWA, Chita-gun (JP)

(73) Assignee: DENSO WAVE INCORPORATED, Chita-gun (JP)

(21) Appl. No.: 15/915,012

(22) Filed: Mar. 7, 2018

(30) Foreign Application Priority Data
Mar. 15, 2017 (JP) 2017-049861

(51) Int. Cl. H01Q 9/04; H01Q 1/48; H01Q 9/42

(52) U.S. Cl. CPC H01Q 9/0421; H01Q 9/0414; H01Q 1/243; H01Q 9/42; H01Q 1/48

(57) ABSTRACT

An antenna device includes a ground and a folded antenna element. The ground has a side which has a length Gx smaller than or equal to λ/2 when a signal wavelength is defined as A. The folded antenna element is connected to the side of the ground at a connection point and has a folded element portion folded in a folding direction. Gx1 is defined as a length of a portion of the side between the connection point and an end of the side away from the folded element portion in a direction opposite to the folding direction. The length Gx1 satisfies inequalities: 0≤Gx1<Gx/2.

### CROSS REFERENCE TO RELATED APPLICATION

This application is based on and incorporates herein by reference Japanese Patent Application No. 2017-049861 filed on Mar. 15, 2017.

### TECHNICAL FIELD

The present disclosure relates to an antenna device including a folded antenna element disposed on a side of a ground.

### BACKGROUND

When an inverted-F antenna which is a type of a folded antenna is connected to a side of a ground, the inverted-F antenna is generally connected to a center of the side of the ground. As disclosed by Patent Literature (e.g. JP 2013-93645 A), the inverted-F antenna may be connected to a position displaced from the center of the side of the ground.

### SUMMARY

It is found that, when an inverted-F antenna element is connected to a center of a side of a ground, a main beam of the antenna element may be inclined at an approximately 45-degree angle from the side of the ground.

It is an object of at least one embodiment is to provide an antenna device capable of reducing an inclination of a main beam of a folded antenna element with respect to a side of a ground.

An antenna device of at least one embodiment includes a ground and a folded antenna element. The ground has a side which has a length Gx smaller than or equal to λ/2 when a signal wavelength is defined as A. The folded antenna element is connected to the side of the ground at a connection point and has a folded element portion folded in a folding direction. Gx1 is defined as a length of a portion of the side between the connection point and an end of the side away from the folded element portion in a direction opposite to the folding direction. The length Gx1 satisfies inequalities: 0≤Gx1<Gx/2. Accordingly, an inclination of a main beam of the folded antenna element with respect to the side of the ground can be reduced.

### BRIEF DESCRIPTION OF THE DRAWINGS

The disclosure, together with additional objectives, features and advantages thereof, will be best understood from the following description, the appended claims and the accompanying drawings, in which:

FIG. 1 is a diagram illustrating an antenna device according to at least one embodiment;

FIG. 2 is a diagram illustrating an antenna device according to at least one embodiment;

FIG. 3 is a diagram illustrating an antenna device according to a comparative example;

FIG. 4 is a diagram illustrating change in direction of main beam of an antenna element from the comparative example to the embodiment;

FIG. 5 is a diagram illustrating change in direction of main beam of the antenna element in accordance with a connection point between the antenna element and a ground;

FIG. 6 is a diagram illustrating a current flow in the antenna device according to the comparative example;

FIG. 7 is a diagram illustrating a simulation result of radio emission of the antenna device according to the comparative example;

FIG. 8 is a diagram illustrating a current flow in the antenna device according to at least one embodiment; and

FIG. 9 is a diagram illustrating a simulation result of radio emission of the antenna device according to at least one embodiment;

### DETAILED DESCRIPTION

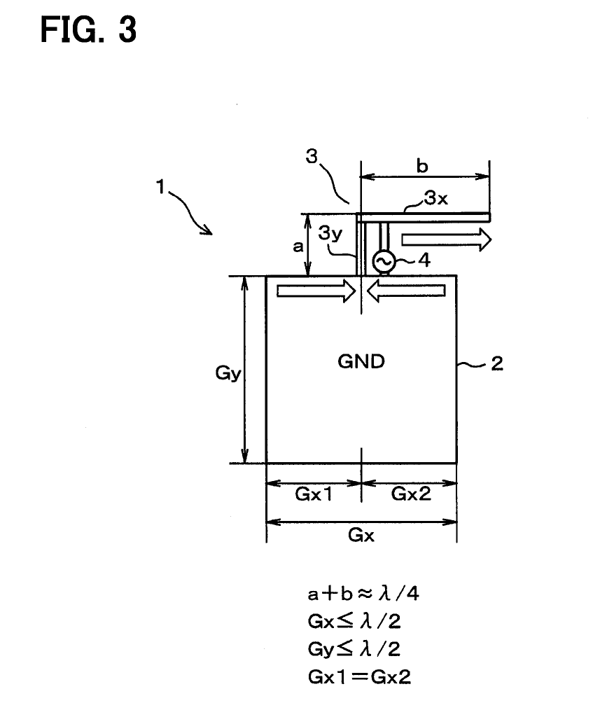

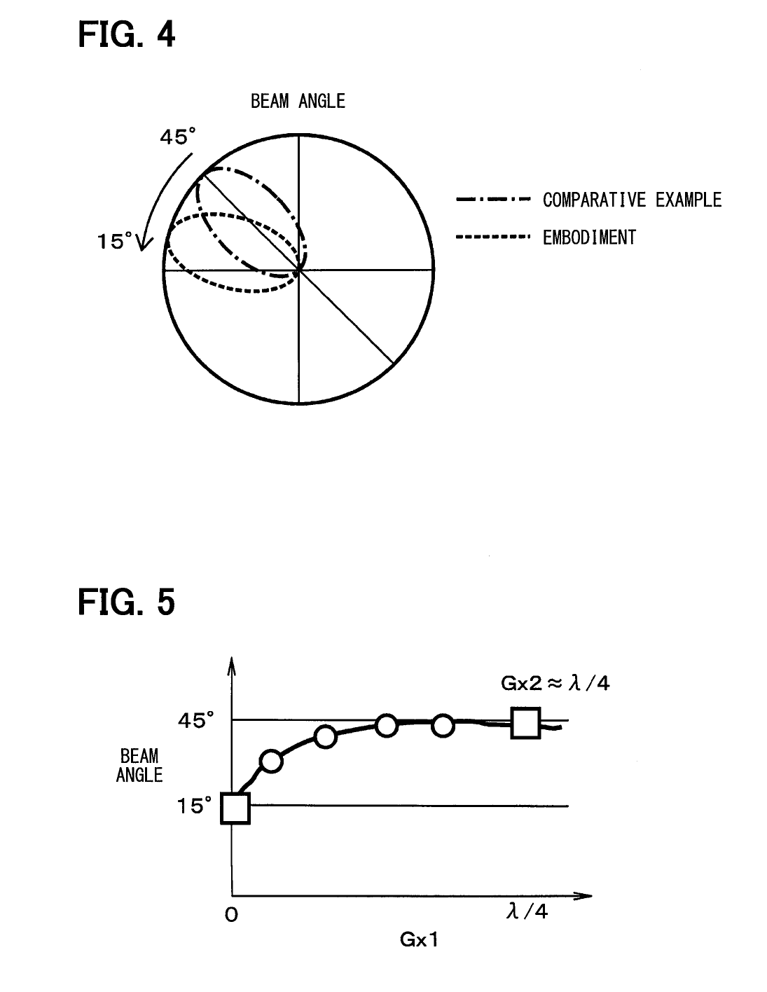

An embodiment will be described with reference to the drawings. First, a configuration of an antenna device of a comparative example will be described with reference to FIG. 3. The antenna device 1 includes a ground 2 having a square shape and formed by, for example, a wiring pattern on a dielectric substrate which is not shown in the drawings, and an antenna element 3 connected to the ground 2. In the drawings, a length of the ground 2 in a horizontal direction is defined as Gx, a length of the ground 2 in a vertical direction is defined as Gy, and a wavelength of a communication signal is defined as λ. Gx and Gy satisfy the inequalities: Gx≤λ/2, and Gy≤λ/2. The wavelength λ is expressed by λ=λ0/√ϵ, where λ0 is the wavelength of light, and √ϵ is a dielectric constant of the dielectric substrate.

The antenna element 3 is an inversed-F antenna which is a type of a folded antenna. The antenna element 3 includes a vertical element portion 3y and a horizontal element portion 3x. The antenna element 3 may consist of the vertical element portion 3y and the horizontal element portion 3x. The horizontal element portion 3x is connected to the ground 2 through the vertical element portion 3y. The horizontal element portion 3x is connected to the ground 2 through a feeding point 4. The horizontal element portion 3x may be directly connected to the vertical element portion 3y. The horizontal element portion 3y may be directly connected to the ground 2. When a length of the vertical element portion 3y is defined as a, and a length of the horizontal element portion 3x is defined as b, the length of the antenna element 3, which is (a+b), is set to be approximately equal to λ/4. The length b of the horizontal element portion 3x may satisfy inequalities: λ/8<b<λ/4. The horizontal element portion 3x may be an example of a folded element portion folded in a folding direction, and may be folded to extend parallel to a side of the ground 2 to which the antenna element 3 is connected. The vertical element portion 3y may be an example of a first portion of the antenna element 3 extending from a side of the ground 2 in a first direction. The horizontal element portion 3x may be an example of a second portion of the antenna element 3 extending from the first portion in a second direction different from the first direction.

A connection point at which the vertical element portion 3y of the antenna element 3 is connected to a side of the ground 2 is defined as Gx1 when a left end of the side is used as a reference (i.e. zero). In other words, a length of a portion of the side of the ground 2 extending from the connection point to the left end can be defined as Gx1. On the other hand, a length of a portion of the side of the ground 2 extending from the connection point to a right end of the side is defined as Gx2. Therefore, Gx satisfies the equality: Gx=Gx1+Gx2. In the antenna device 1 of the comparative example, the vertical element portion 3y is connected to a center of the side of the ground 2, which means Gx1=Gx2=λ/2.

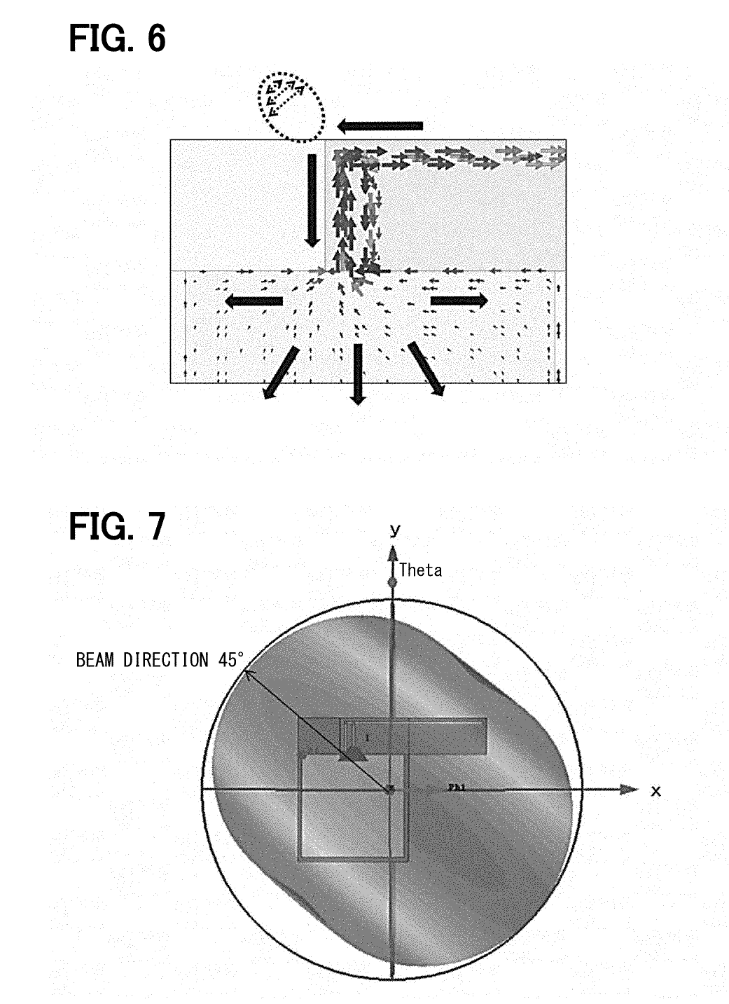

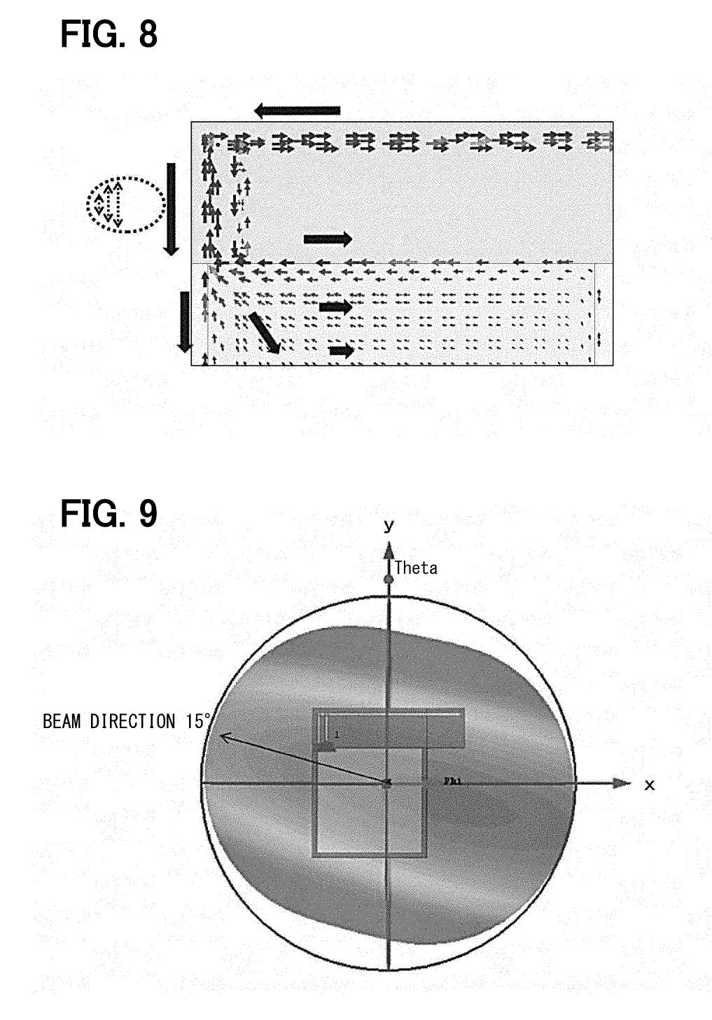

In the comparative example, simulation results of current flow in the antenna element 3 and the ground 2 during communication of the antenna device 1 are shown in FIG. 6. Large arrows in FIGS. 6 and 8 represent current flows which are opposite to flows represented by small arrows in a manner of alternate current. A current flow in the horizontal element portion 3x of the antenna element 3 and a current flow in a side portion of the ground 2 that faces the horizontal element portion 3x are opposite in flow direction and cancel each other out.

When the vertical element portion 3y is connected to the center of the side of the ground 2, a current flows also in a left portion of the ground 2 in FIG. 3 that does not face the horizontal element portion 3x. Consequently, the current flow in the horizontal element portion 3x may not be cancelled sufficiently, and thereby causes a radio wave component along a direction inclined at approximately 90-degree angle from the horizontal direction. A current flow in the vertical element portion 3y causes a radio wave component along a direction inclined at approximately 0-degree angle from the horizontal direction. As a result of combination of the radio wave components caused by the current flows in the horizontal element portion 3x and the vertical element portion 3y, a main beam of the antenna device 1 is upward and inclined at 45-degree angle from the horizontal direction as shown by dashed arrows in FIG. 6.

FIG. 7 is a simulation result of radio emission of the antenna device 1 corresponding to the state of FIG. 6 and shows that the beam direction is upward and inclined at 45-degree angle from x-axis that corresponds to the horizontal direction.

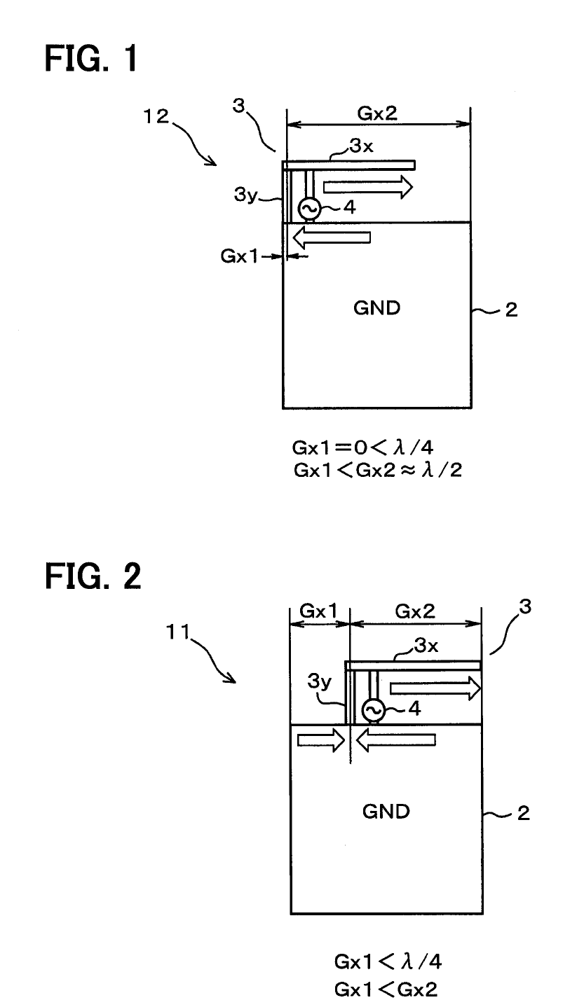

According to an antenna device 11 of an embodiment, as shown in FIG. 2, the connection point Gx1 of the vertical element portion 3y is set to satisfy the inequalities: Gx1<λ/4, and Gx1<Gx2. That is, the connection point Gx1 is between the center and the reference left end of the side. Alternatively, as shown in FIG. 1, in an antenna device 12, the connection point Gx1 may be on the left end, i.e. Gx1=0. For the antenna device 12, as shown in FIG. 8, the current flow in the horizontal element portion 3x can be sufficiently cancelled by the current flow in the side portion of the ground 2. Therefore, the radio wave component along the direction inclined at approximately 90-degree angle from the horizontal direction can be reduced effectively. As a result, a main beam of the antenna device 12 is upward and inclined at 15-degree angle from the horizontal direction, as shown by dashed arrows in FIG. 8.

FIG. 9 is a simulation result of radio emission of the antenna device 12 corresponding to the state of FIG. 8 and shows that the beam direction is upward and inclined at 15-degree angle from the horizontal direction, as described above. Based on the results shown in FIGS. 7 and 9, a main beam of the antenna device 11 of FIG. 2 is expected to be inclined at between 45-degree and 15-degree angle from the horizontal direction, as shown by plots “o” in FIG. 5.

According to the embodiment, the antenna element 3 having a length of λ/4 is connected, at the connection point Gx1, to the side of the ground 2 having a length of λ/2 or less. As shown in FIG. 2, when an end of the side of the ground 2 away from the position Gx1 in a direction opposite to an extending direction of the horizontal element portion 3x from the vertical element portion 3y is defined as a reference (i.e. zero), Gx1 satisfies the inequalities: 0≤Gx1<Gx/2. In other words, Gx1 can be defined as a length of a portion of the side of the ground 2 between the connection point and the end of the side away from the horizontal element portion 3x in the direction opposite to the folding direction, and Gx1 satisfies the inequalities: 0≤Gx1<Gx/2. Therefore, the connection point Gx1 is displaced from the center of the side of the ground 2 toward the reference. Hence, the current flow in the horizontal element portion 3x of the antenna element 3 can be cancelled effectively by the current flow in the ground 2. Consequently, generation of a radio wave component along a direction inclined at approximately 90-degree angle from the horizontal direction can be reduced, and the main beam of the antenna device 11 can be made to be closer to the horizontal direction. In other words, an angle between the main beam of the antenna device 11 and the horizontal direction can be reduced.

Alternatively, as shown in FIG. 1, when the connection point Gx1 is set at the reference position that is the end of the side of the ground 2, i.e. Gx1=0, the generation of the radio wave component along the direction inclined at approximately 90-degree angle from the horizontal direction can be further reduced, and the main beam of the antenna device 12 can be made to be much closer to the horizontal direction. In other words, an angle between the main beam of the antenna device 12 and the horizontal direction can be further reduced.

The present disclosure is not limited to the embodiments described above or shown in the drawings and can be modified or expanded as below.

When the direction in which the horizontal element portion 3x extends from the vertical element portion 3y is leftward in FIG. 1, a right end of the side of the ground 2 may be used as the reference position. The shape of the ground 2 is not limited to the square shape, and may be a rectangular shape. The antenna element 3 is not limited to the inverted-F antenna element, and may be an inverted-L antenna element. The number of folded antenna elements connected to the side of the ground 2 may be one.

According to the present disclosure, the antenna device includes a ground having a side whose length Gx is smaller than or equal to λ/2, and a folded antenna element having a length of λ/4. The folded antenna element is connected the side of the ground at a connection point Gx1. When an end of the side away from the connection point in a direction opposite to the folding direction of the folded element portion of the folded antenna element is defined as a reference, i.e. zero, Gx1 satisfies inequalities: 0≤Gx1<Gx/2. In other words, the connection point is displaced from a center of the side of the ground in the direction opposite to the second direction. When the antenna device is in communication, and an alternating-current signal flows in the antenna element, electric current flows in both the element and the side of the ground facing each other. A current flow in the second portion of the antenna element and a current flow in the side of the ground facing the element are opposite to each other and cancel each other out (refer to, for example, the arrows in FIG. 1).

If the antenna element is connected to the center of the side of the ground as in the comparative example, an electric current flows in a portion of the ground which does not face the antenna device. When the side of the ground and the folded element portion of the antenna element are, for example, parallel to the horizontal direction, the current flow in the horizontal portion, of the antenna element may not be cancelled by the current flow in the ground. Therefore, the horizontal portion of the antenna element may cause a radio wave component emitted along a direction inclined at approximately 90-degree angle from the horizontal direction. The radio wave component is combined with a radio wave component which is emitted from the vertical portion, of the antenna element along a direction inclined at approximately 0-degree angle from the horizontal direction. As a result, the combined radio wave is emitted along a direction inclined at approximately 45-degree angle from the horizontal direction.

In the present disclosure, in contrast, the connection point Gx1 between the folded antenna element and the ground is displaced from a center of the side of the ground toward the reference end, which means 0≤Gx1<Gx/2. That is, a distance of the ground facing the horizontal portion of the antenna element is lengthened. Accordingly, the radio wave component along the direction inclined at approximately 90-degree angle from the horizontal direction can be reduced, and a main beam of the antenna element can be made to be closer to the horizontal direction.

The connection point Gx1 may satisfy inequalities: 0≤Gx1<Gx/4. In this case, the main beam can be made to be much closer to the horizontal direction. The connection point Gx1 may be zero, i.e. reference position, the end of the side of the ground. The ground may have a square shape.

While the present disclosure has been described with reference to various exemplary embodiments thereof, it is to be understood that the disclosure is not limited to the disclosed embodiments and constructions. To the contrary, the disclosure is intended to cover various modifications and equivalent arrangements. In addition, while the various elements of the disclosure are shown in various combinations and configurations, which are exemplary, other various combinations and configurations, including more, less or only a single element, are also within the spirit of the disclosure.

What is claimed is:

1. An antenna device comprising:
a ground having a side which has a length Gx smaller than or equal to λ/2 when a signal wavelength is defined as λ, and
a folded antenna element connected to the side of the ground at a connection point and having a folded element portion folded in a folding direction, wherein
Gx1 is defined as a length of a portion of the side between the connection point and an end of the side away from the folded element portion in a direction opposite to the folding direction, and the length Gx1 satisfies inequalities: 0≤Gx1<Gx/2.

2. The antenna device according to claim 1, wherein the length Gx1 satisfies inequalities: 0≤Gx1<Gx/4.

3. The antenna device according to claim 2, wherein the length Gx1 satisfies an equality: Gx1=0.

4. The antenna device according to claim 1, wherein the ground has a square shape.

5. The antenna device according to claim 1, wherein the folded antenna element has a length of λ/4.

6. The antenna device according to claim 1, wherein the folded element portion is folded to extend parallel to the side of the ground.

7. The antenna device according to claim 1, wherein a length b of the folded element portion satisfies inequalities: λ/8<b<λ/4.

8. The antenna device according to claim 1, wherein a number of folded antenna elements connected to the side of the ground is one.
